(19) United States
(12) Patent Application Publication
(10) Pub. No.: US 2025/0332672 A1
(43) Pub. Date: Oct. 30, 2025

(54) TOOL TRANSPORT SYSTEM AND METHOD FOR EXCHANGING TOOLS AT MACHINE TOOLS

(71) Applicant: DECKEL MAHO Pfronten GmbH, Pfronten (DE)

(72) Inventors: Sebastian RIEDEL, Eisenberg (DE); Michael TRENKLE, Pfronten (DE)

(21) Appl. No.: 18/294,458

(22) PCT Filed: Jul. 7, 2022
(86) PCT No.: PCT/EP2022/068847

§ 371 Date: Jan. 7, 2025

(30) Foreign Application Priority Data
Aug. 6, 2021 (DE) 10 2021 120 497.6

(51) Int. Cl. B23Q 3/155

(52) U.S. Cl. CPC B23Q 3/1554; B23Q 2003/155407

(57) ABSTRACT

The present invention relates to a tool transport system for exchanging tools between a central tool magazine and one or more machine tools. A guided transport module P can be moved between different stops by means of a supporting guide. The transport module P has a transport platform PT with at least one tool transport strip E2 for holding a plurality of tools W. The transport platform PT is downwardly spaced apart, in the vertical direction, from the transport module P and from the supporting guide F.

The present invention relates to a tool transport system for exchanging tools between a central tool magazine for storing a plurality of tools and one or more machine tools. In addition, a method for exchanging tools on machine tools using a central tool magazine to receive a plurality of different tools is proposed.

EP 2 750 828 B1 describes a tool changing device on a tool magazine of a machine tool. The tool is inserted by means of a manipulator on a tool magazine having one or more tool magazine wheels. Here, the tool magazine itself is loaded manually.

DE 10 2018 201 426 A1 shows a feed device for tool magazines of a machine tool, which allows a tool or workpiece magazine to be loaded in a partially automated manner. Here, an additional tool strip is provided that can be loaded manually by an operator. The tool strip with manually loaded tools can then be fed from the loading positions accessible by the operator to a transfer position via a lifting and rotating device of the feed device.

Starting from the known machine tools and tool magazines, it is an object of the present invention to provide an efficient tool transport system with which it is possible to easily provide tools to various machine tools. It is also an object to enable an efficient exchange of tools from different machine tools. In addition, it is an object to propose a method with which the exchange of tools on machine tools can be carried out efficiently and preferably without interrupting the machining cycles.

In order to achieve the objects, the features of the independent claims are proposed. Preferred further developments may be found in the dependent claims.

A tool transport system for exchanging tools between a central tool magazine and one or more machine tools may comprise at least: a guided transport module for shuttling between a central tool magazine and one or more machine tools along a transport path; a supporting guide for receiving the transport module and for determining the transport path of the transport module, wherein the transport module comprises a transport platform having at least one tool transport strip for receiving a plurality of tools, and wherein the transport platform is preferably spaced apart downwardly, in the vertical direction, from the transport module. By means of this arrangement and the use of the central tool magazine, it is possible to efficiently insert/remove a plurality of tools from a central magazine on the machine tools without interrupting the machining cycles and without obstructing the space around the machine tool (horizontal access area to the machine tool). The vertical tool feed combined with the central tool magazine and the rotatable transport platform is therefore an extremely efficient way to insert tools.

The transport platform may preferably be configured to be rotatable about a vertical axis in order to change the spatial orientation of the tool transport strip. This arrangement allows the transport platform to be used flexibly and efficiently for tool changes. The loaded strip can be rotated in the direction of movement for the translational movement of the transport platform in order to enable safe and low-vibration transport of the tools. The rotation also makes it possible to use the back of the transport platform for changing tools, for example using an additional tool transport strip. Therefore, inserting and removing on a machine tool or the magazine is possible with just one shuttle path.

A support frame for receiving and rotatably mounting the transport platform may be provided and the support frame may preferably completely frame the transport platform in at least one plane in order to ensure safe and low-vibration support. The support frame may be provided hanging on the transport module in order to enable improved access and thus quick tool changes.

The transport module may include a first drive for moving along the transport path and a second drive for rotating the transport platform about a vertical axis. This configuration makes it possible to keep the drives small and place them close to the movement axes in order to enable low-vibration and robust movements. In addition, these integrated drives are advantageously powered via the power supply on the rails to enable efficient energy transfer. In a preferred development, a vertical movement of the transport platform itself is not allowed (i.e. rigid arrangement in the vertical direction), so that the weight of the transport platform can be further reduced, therefore making it possible to minimize the masses to be moved.

The supporting guide may be arranged vertically spaced from the central tool magazine and/or the machine tools, with the supporting guide preferably being arranged at least partially above the central tool magazine and/or the machine tools (e.g. on the hall roof of a machine hall or on columns which extend vertically beyond the machine tools). The overhead arrangement makes it possible to transport the tools freely across the machine tools, preferably with minimal transport distances in order to directly control the machine tools for tool changes.

The supporting guide may comprise at least one rail with which guide means of the transport module engage, the transport module being displaceable and preferably only mounted on the supporting guide. The rails advantageously establish a direct path between the tool magazine and the machine tool to enable efficient tool transport. Engaging and mounting the transport module only on the rails allows for efficient assembly and rapid tool transport with reduced energy requirements.

The transport platform may include a first tool transport strip and a second tool transport strip, which are preferably arranged opposite one another (preferably spaced and parallel to one another). Each tool transport strip may include a plurality of transport holders for mounting tools in a loading direction. The loading direction of the first and second tool transport strips may be configured to be in opposite directions. By rotating the transport platform about the vertical axis, which is preferably the longitudinal axis of the transport platform, tools can be changed using the first or second tool transport strip. This structure allows for a particularly efficient tool change of a plurality of tools in one changing operation.

The transport platform may be received on a mounting shaft and the mounting shaft may be mounted on the support frame, the second drive being connected to the storage shaft by means of engagement means and rotating the storage shaft in order to rotate the transport platform. This allows for efficient and low-vibration rotation of the transport platform.

The supporting guide may have stops along the transport path, which are each assigned to the central tool magazine and the at least one machine tool and at which the transport module stops to change tools.

Advantageously, the transport module may be a shuttle car having rollers for rapid movement, which includes a self-drive that drives the transport module along the rails of the supporting guide, and wherein the self-drive is in particular the first drive.

A production system may include at least one machine tool, a central tool magazine for storing tools and a tool transport system. The central tool magazine and the at least one machine tool may each include a tool provision strip that can be moved into a transfer position for tool changing with the tool transport strip of the transport module.

The tool provision strip may advantageously be movable vertically upwards into the transfer position and back and the tool provision strip may be configured to carry out an upward lifting movement or a downward lifting movement in order to transfer the tools to the tool transport strip in the transfer position. The disclosure of DE 10 2018 201 426 B1 and AKZ DE 10 2020 211672.5 is hereby incorporated by reference.

To transfer the tools, the tool transport strip may advantageously be configured to move into an overlapping position with the tool provision strip so that tool grippers of the tool transport strip and the tool provision strip are arranged one above the other.

A method for exchanging tools between a central tool magazine and one or more machine tools by means of a tool transport system, wherein the central tool magazine and the at least one machine tool each include a tool provision strip and wherein the tool transport system comprises a guided transport module having at least one tool transport strip and a supporting guide for receiving the transport module and determining the transport path of the transport module, said method comprising the steps of: shuttling the transport module between stops on the transport path at a central tool magazine and one or more machine tools along a transport path; exchanging tools at the stops by a lifting movement the tool provision strip.

In addition, the following steps may advantageously be provided: moving the tool provision strip vertically upwards into a transfer position and then preferably moving the tool transport strip into an overlapping position with the tool provision bar; and, in order to transfer the tools to the tool transport strip in the transfer position, carrying out an upward lifting movement or a downward lifting movement of the tool provision bar; and/or rotating the transport platform about a vertical axis to change the spatial orientation of the tool transport strip for exchanging the tools.

Further aspects and advantages thereof as well as special implementation options for the aspects and features described above are apparent in the following sections and explanations.

### FIGURES

FIG. 1 shows a first overview of the tool transport system including the transport module (P);

FIG. 2 shows a further diagram of the tool transport system, with the transport platform in a neutral position (tool transport strip (E2) is at right angles to the transport path along the rails);

FIG. 3 shows a detailed representation of the transport module including the transport platform (PT);

FIG. 4 shows an overview of a central tool magazine and the tool transport system arranged thereabove;

FIG. 5 shows a further diagram of the tool transport system, which is arranged above the central tool magazine and the individual machine tools;

FIG. 6 shows a side view of the tool transport system above the central tool magazine and the machine tool;

FIG. 7 shows another side view of the tool transport system;

FIG. 8 shows a top view of the tool transport system with the machine tools and a central tool magazine;

FIG. 9 shows the transport platform (PT) in a twisted position relative to the travel path

Examples or embodiments of the present invention are described in detail below with reference to the attached figures. The same or similar elements in the figures may be designated with the same reference symbols, but if appropriate also with different reference symbols.

It is to be noted that the present invention is in no way limited to the exemplary embodiments described below and embodiment features thereof, but further includes modifications of the exemplary embodiments, in particular those that are included within the scope of protection of the claims by modifying the features of the examples described or by combining one or more of the features of the examples described.

The operations described below relating to the loading or unloading of tools from the tool provision strips or tool transport strips can preferably always be carried out bidirectionally. That is, both unloading and loading are possible even if sometimes only one unloading process or one loading process is described in the following.

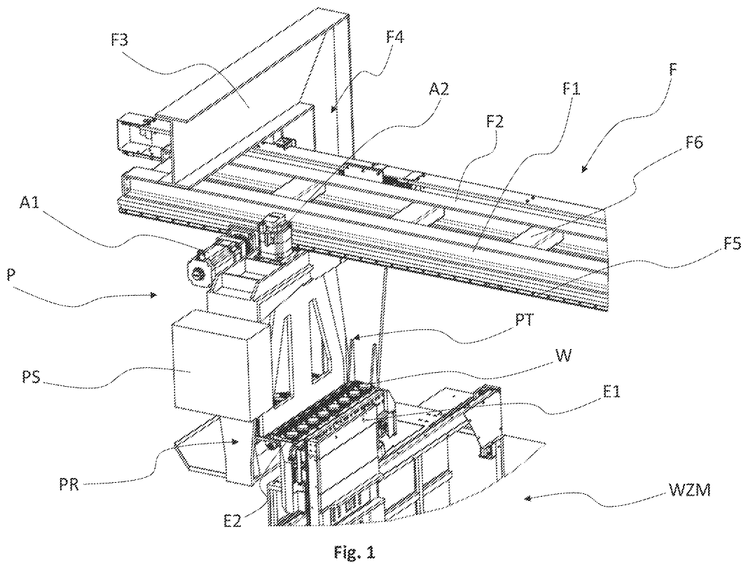

FIG. 1 shows the tool transport system for exchanging tools between a central tool magazine ZWM and a machine tool WZM. The tool transport system includes a transport module P, which is also referred to as a shuttle module. The shuttle module has a self-drive and can be moved translationally along the supporting guide F. The transport module P also includes a transport platform PT, which is attached to the transport module P in a hanging manner. The transport platform PT is therefore preferably only attached to a single side and the other sides are free.

The supporting guide F is arranged in the area above the machine tools WZM or the central tool magazine ZWM via a horizontal support F3 and a vertical support F4. This overhead arrangement with respect to the machine tool and the central tool magazine makes it possible to transport the corresponding tools by means of the transport module P across the individual machine tools and the central tool magazine, preferably on a direct path. This keeps the work area around the machine tools or around the central tool magazine free to enable efficient tool exchange without interrupting the machining cycles. In other words, the supporting guide F is preferably arranged higher in the vertical direction than the upper end of the individual machine tools and/or the central tool magazine by means of a first and a second rail F1 and F2. The transport module P is therefore more distant from the floor on which the machine tool and the tool magazine are provided than the upper end of the individual machine tools and the central tool magazine.

The supporting guide F includes a first rail F1, which is configured, for example, as an I-profile support, and a second rail F2, which is preferably also configured as an I-profile support. On the bottom side of these rails, towards the workshop floor, the transport module P may be provided via sliders or rollers, so that the transport module P can slide or roll along the rails. The guide surfaces of the rails are preferably facing towards the workshop floor or floor. Alternatively, the supporting guide F comprises a profile support which is arranged along the transport path, with a rail being fixed on the bottom side. Preferably, two profile supports are provided, with each profile support being assigned its own rail, namely the first rail F1 and the second rail F2, which preferably extend in parallel to one another along the transport path.

The profile supports of the supporting guide F are preferably firmly connected to one another via struts F6, so that a distance between the beams or between the first rail F1 and the second rail F2 is constantly ensured over the entire transport path. The supporting guide F having the profile support is also configured to absorb the entire weight and loading force of the transport module P, which is provided hanging on the rails.

The profile beams are in turn firmly connected to the horizontal beam F3, for example via screw connections or welded connections. Preferably, all structural components of the transport module P and in particular the transport platform PT are arranged below the supporting guide F in the vertical direction. The hanging arrangement of the transport module P also enables safe and easy access to the sliders or rollers of the transport module P, which are in engagement with the rails, so that efficient maintenance is possible. On the bottom side of the supporting guide, i.e. the side that faces the workshop floor, there is preferably the rack F5, which can be used to enable the transport module P to move along the transport path using the self-drive. Particularly preferably, only one rack F5 is provided, which is provided along the first rail F1 and which has markings for position recognition by means of the transport module P. Particularly preferably, the transport module P therefore always autonomously recognizes its own position along the transport path.

The supporting guide F, which is attached to the horizontal support F3 via the profile supports, is preferably configured such that the horizontal support F3 is only attached to one side of a vertical support F4, so that the interconnected supports F3 and F4 form an L-shape. The two supports are preferably welded together, with the vertical support F4 being screwed to the workshop floor opposite the connection point of the vertical support F4 with the horizontal support F3. This support configuration is preferably provided at least at every stop of the transport module P along the transport path. This ensures a stable tool transfer from the transport module P to the respective machine tool or the central tool magazine assigned to the stop H1, H2, H3, H4. In particular, mechanical vibrations that may arise during the transfer process can be efficiently absorbed so that a safe and precise transfer of the tools can be achieved.

The transport module P is provided hanging on the bottom side of the supporting guide F. The engagement means, such as sliders or rollers of the transport module P, engage on the rails of the supporting guide F, so that a sliding mount of the transport module P on the rails or the profile supports of the supporting guide F can be achieved. The transport module P is configured to be translationally movable along the rails and, particularly advantageously, this movement can be controlled by the first drive A1. The first drive A1 is attached directly to the transport module B and preferably has a horizontal orientation. The first drive A1 can engage with the rack F5 via appropriate gear wheels in order to cause a forward or backward movement of the transport module B along the transport path. The energy is transferred to the first drive, for example, via appropriate cable connections, which are provided on the profile support and can be carried along with the transport module B. Advantageously, the energy transfer is carried out via a carrier that is dragged along the rails. Alternatively, contactless energy transfer is provided, for example by induction.

The first drive A1 is therefore preferably provided on the top of the transport module P, directly next to a rail of the supporting guide F. On the same side and preferably next to the first drive A1, a second drive A2 is provided, which preferably has a vertical orientation of the longitudinal axis and which is intended to carry out a rotational movement of the transport platform PT. The transport platform PT includes the tool transport strip E2, in which a plurality of tools W can be inserted. In the example shown in FIG. 1, eight tools W can be used in a tool transport strip E2. Another tool transport bar, which again can hold a plurality of tools W, is shown opposite the tool transport strip E2. The transport platform PT is configured to be rotatable by means of the second drive A2, so that the orientation of the tool transport strip relative to the transport path or the longitudinal direction of the rails can be determined. By rotating the transport platform PT through 180°, a first or a second tool transport strip E2 can be arranged in such a way that it is at the front of the transport module and therefore in the direction of movement along the transport path. Conversely, a rotation of the transport platform PT can of course also be used to rotate a tool transport strip E2 in such a way that it is arranged towards the rear of the transport module P, i.e. against the direction of movement along the transport path.

When navigating to a corresponding stop with the aim of transferring tools, it is therefore possible to establish corresponding tool locations on the tool transport strip E2 for contact with the receiving device of the machine tool WZM or the central tool magazine ZWM by means of the rotational movement of the transport platform PT. The rotational movement of the transport platform PT also makes it possible to insert and remove tools W between two stops in just one shuttle movement of the transport module P. For example, a first tool transport strip E2 may be used to insert corresponding tools W; and for removing tools, the transport platform PT may be rotated in such a way that the second tool transport strip E2 is moved into the contact area with the transfer unit of the machine tool WZM or the central tool magazine ZWM. For a process of inserting and simultaneously removing, it is therefore not necessary for the transport module P to move a plurality times between two stops.

When approaching a stop, the rotatable transport platform PT makes it possible, for example, to insert tools into the first tool transport strip E2* and to remove tools from the second tool transport strip E2, so that maximum flexibility and efficiency can be achieved in the tool changing process.

Particularly preferably, the rotational movement of the transport platform is controlled directly by the transport module control PS, which is provided directly on the transport module P. For the inserting operation itself, it is not necessary for the transport platform PT to carry out a vertical movement, since this vertical movement is carried out, for example, as an upward stroke or a downward stroke on the machine tool side. By avoiding this vertical movement of the transport platform, it is possible to make the transport module particularly light, so that the masses to be moved can be greatly reduced and faster transport along the transport path can be achieved.

Another component of the transport module P is the support frame PR attached in a hanging manner. The support frame PR is configured such that it encloses the transport platform PT and preferably frames it at least in one plane. This frame serves as a stabilization and support mechanism for the rotatable transport platform PT. The rotatable transport platform PT is rotatable mounted on the support frame PR via a rotary shaft. The transport module control PS is provided on the lateral support frame PR.

In FIG. 1, the transport module P is shown in the engagement position with the tool provision strip of the machine tool WZM. The machine tool WZM includes a tool lift E1 with a loading strip E1B, which can be moved vertically upwards. For the engagement operation, the tools held in the tool transport strip E2 in the vertical direction can be lifted out of the tool transport strip E2 by a lifting movement of the tool lift of the machine tool or can be inserted into said tool transport strip E2 by a downward lifting movement. The tools from the tool transport strip E2 can therefore be exchanged by the lifting movement of the tool provision strip of the machine tool. A lifting movement of the transport module P can thus be avoided.

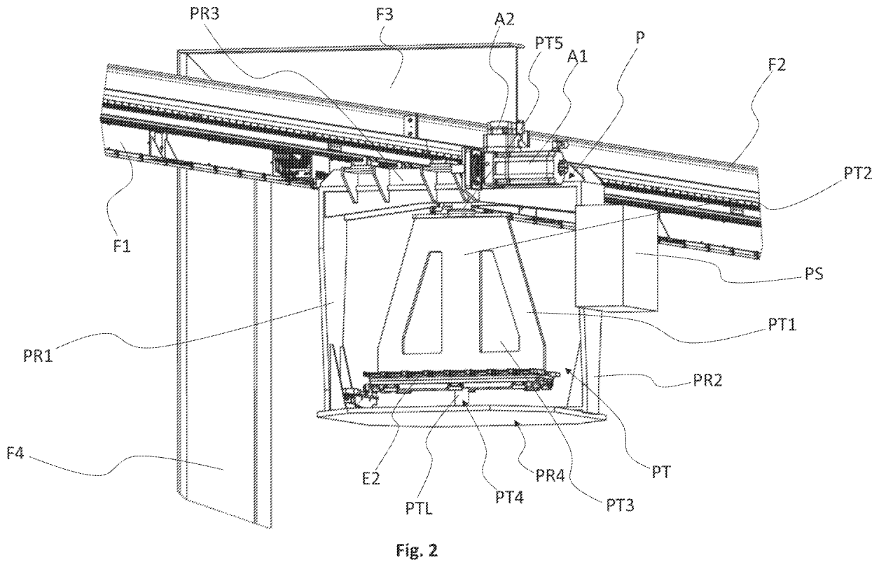

A further diagram of the tool transport system is shown in FIG. 2. The transport platform PT shown includes a central middle piece which connects the top with the bottom of the transport platform PT. This central platform receptacle PT2 is therefore arranged such that the axial extent is aligned according to the axis of the transport platform PT. For further stabilization, there are laterally spaced side platform receptacles PT1 to the right and left of the central platform receptacle PT2. Both the central platform receptacle PT2 and the side platform receptacles PT1 open jointly at an upper connecting portion and a lower connecting portion. In the intermediate area, the openings PT3 are provided to optimize the vibration properties of the transport platform PT and to further save weight. The tool transport strips E2, E2*, which are preferably directly connected to the side platform receptacle and the central platform receptacle PT1, PT2 with the fastening portion on the bottom side, are provided on the lower fastening portion. The transport platform also includes a rotary shaft PTL, which protrudes in vertical direction on the top side and on the bottom side of the transport platform PT. These protruding portions form a rotary shaft. This rotary shaft provides a lower rotation axis portion PT4 on the bottom side of the transport platform PT for receiving and storing the transport platform PT and an upper rotation axis portion PT5 on the top side of the transport platform PT for supporting the rotational path of the transport platform PT and for absorbing the axial forces, such as the weight forces.

The rotary shaft of the upper and lower rotary axis portions opens into respective rotary shaft receptacles of the support frame PR. Said receptacles of the support frame PR allow the rotary shaft to rotate. The rotary shaft may also be referred to as a mounting shaft PTL since it realizes a mounting of the transport platform PT while enabling a rotational movement about the mounting shaft axis. The mounting shaft axis is a vertical axis.

The support frame PR includes two opposite side supports PR1 and PR2. These side supports are each configured as a cross-section that tapers in cross-section and therefore becomes smaller towards the workshop floor, formed as a support or as a profile. On the bottom side of the side supports PR1 and PR2, there is a lower carrier support PR4 which firmly connects the first and second side supports PR1 and PR2 to one another. At the top side of the side supports PR1 and PR2, there is the upper carrier support PR3 which firmly connects the side supports PR1 and PR2 to one another. The transport module control PS, which can be used to control the first and second drives as well as to detect the position of both the rotational position of the transport platform and the position of the transport module along the transport path, is preferably provided on the outer side surface of the side support PR2.

FIG. 2 also shows the L-shaped support arrangement with the vertical support F4 and the horizontal support F3 attached thereto. The support arrangement receives the supporting guide at the top side. The transport module P provided on the rails via the sliders is firmly connected to the support frame PR, which is firmly attached to the sliders while hanging downwards. The rotational axis of the mounting shaft PTL is also provided between the sliders of the transport module P in order to enable the transport platform PT to rotate with as little vibration and as effectively as possible.

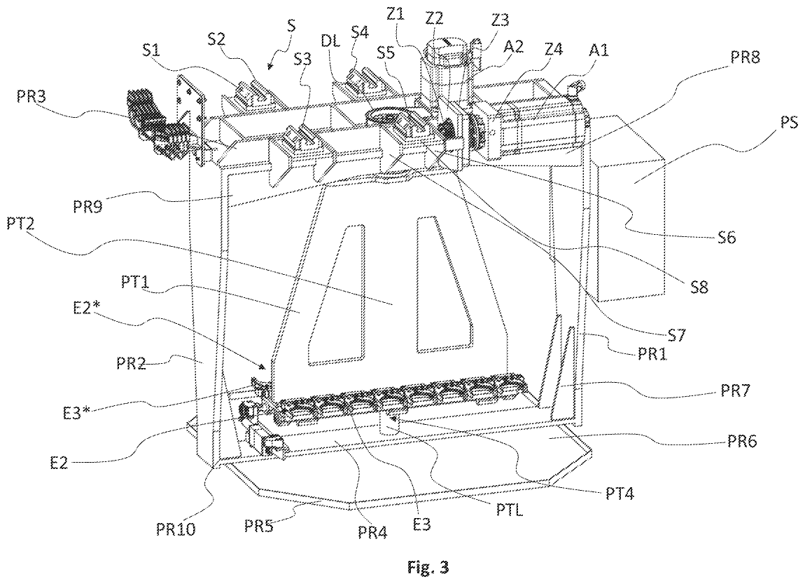

FIG. 3 shows a detailed view of the transport module P. On the top side of the transport module, there are the rail sliders S which serve to support the entire transport module P on the rails. As an alternative to the rail gliders, rollers, which can engage on the rails and are suitable for the corresponding power transmission, may also be provided. The rail sliders shown in FIG. 3 have a guide passage through which the rails can be guided. The cross-section of this passage essentially corresponds to a T-shape, i.e. a narrower cross-section that widens towards one end. The side surfaces of the rail slider, which also form the force transmission surfaces on the rails, are formed by the left jaw S2 and the right jaw S1. These rail sliders, or profile sliders, may also be configured as groove sliders, so that, instead of the rails, the supporting guide F has corresponding profiles with grooves in which the groove sliders engage accordingly. The sliders enable robust guidance of the transport module P along the transport path. The proposed rail sliders are particularly maintenance-friendly and robust and therefore enable reliable movement.

As shown in FIG. 3, a total of four rail sliders S, S3, S4, S5 are provided. The rail sliders are preferably provided at a distance from one another, i.e. without direct contact, on the upper carrier support PR3 of the transport module P. In order to increase the distance of the rail sliders from one another, it is particularly advantageous to propose to provide separate platforms for attaching the rail sliders S to the upper carrier support PR3. The platforms include a fastening plate S8 and two side support plates S6 and S7 which laterally support the fastening plate and which are preferably firmly connected, for example welded, to the upper carrier support. The respective rail slider S is firmly provided on the mounting plate S8 and is screwed onto it, for example. The platforms extend from a side wall of the upper carrier support along the rails of the supporting guide. Two rail sliders with corresponding fastening platforms are preferably provided on a front side of the transport module P and, opposite thereto, two rail sliders, which protrude in the opposite direction from the upper carrier support PR3 or its side wall, are provided on the back of the transport module P along the rails of the supporting guide F. In other words, two rail sliders are provided with the respective platforms protruding from a side wall of the upper carrier support PR3 in a first direction and the two opposing rail sliders are in turn provided on the respective platforms which protrude in the opposite direction from a side wall of the upper carrier support. By means of this configuration, the distance along the travel path between the rail sliders on one side of the upper carrier support and the other side of the upper carrier support is maximized and a particularly preferred stabilization of the transport module P can be achieved, so that safe guidance and rapid transport can be achieved.

The longitudinal direction of the rail gliders is preferably oriented in parallel to the respective rail. The rotational axis of the transport platform PT is provided between the rail sliders S4 and S5, resulting in a particularly stable and reliable rotational movement of the transport platform PT so that the vibrations that occur can be reduced to a minimum.

As can be seen in FIG. 3, the first drive A1 is arranged horizontally. Therefore, the longitudinal axis of the drive is oriented in the horizontal direction. The drive is connected to the support frame via a flange Z4. The power is transmitted through the counter bearing arrangement Z3 via the gear Z1 via a corresponding gear or directly, that is, without a gear. The gear Z1 is preferably used to achieve direct engagement with the rack F5 and thereby movement of the transport platform. Here, the side plate Z2 serves to stabilize the gear and ensure contact between the rack F5 and the gear F1. As an example, the energy collectors E are provided at the upper corner of the upper carrier support PR3. For supplying energy and transmitting measurement and/or control signals to the transport platform, which includes the upper carrier support PR3, for example side walls, which are welded together via cross struts. At the opposite ends of the upper carrier support PR3 there is one side support each, which preferably extends downwards from the upper carrier support PR3 at 90° and has a tapering cross section.

In the corner area of the upper carrier support at the connection points to the side supports PR2 and PR1, there are two stiffening plates PR9, which are firmly connected and preferably welded to the upper carrier support PR3 and the side support PR2 or PR1. The cross section of this stiffener preferably tapers towards the center of the upper carrier support PR3.

At the lower corner of the second support PR2, there is the lower free area PR10, which is also the connection area of the lower carrier support PR4 with the side support PR2. In this corner area, there is also a stiffener PR7, as is also present on the opposite corner at the connection point between the lower carrier support PR4 and the side support PR1. The lower carrier support PR4 also has a connection to a collecting trough PR6. The collecting trough PR6 is provided to collect lubricants and liquids which, for example, drip down from replaced tools in the transport holder in the Z direction towards the workshop floor. The collecting tray PR6 ensures that, when the tools are transported, even if they soiled with lubricants, chips or dirt, none of these contaminations is left on the machine tool or the workshop floor along the transport path. Particularly preferably, the collecting trough PR6 is at least partially displaceable in order to enable particularly good contact of the transport holder with the tool provision strip of the machine tool or the central tool magazine.

The collecting trough PR6 is provided on the outermost lower side of the transport module P and further has circumferential side walls PR5, which result in an improvement in the capacity of the collecting trough PR6. A mounting point, where the mounting shaft PTL is mounted, is provided in the middle of the lower carrier support PR4. This lower rotation axis portion PT4 is preferably arranged centrally on the lower carrier support PR4. The side support PR1 is firmly connected to the lower carrier support PR4, preferably welded and stiffened via corresponding support plates PR7. The support plates preferably have a tapering cross section, the cross section tapering in the direction of the upper carrier support PR3.

The transport platform PT is mounted to be rotatable through 360° using a rotary shaft on the upper and lower carrier supports. The rotational movement is initiated via the second drive A2, which is arranged on the top side of the transport module, with power being transmitted from the second drive A2 to the rotary shaft, for example via a V-belt mechanism or via a gearbox. On the bottom side of the PT transport platform, there is the tool transport strip E2 with a plurality of receiving spaces for tools. The receiving spaces each include first and second gripper arms which at least partially enclose a tool to be received on the periphery. The gripper arms may be either rigid or alternatively movable, so that the grippers can be opened and closed to enclose the tools. In the example shown, eight receiving spaces are provided per tool transport strip E2. On the back of the tool transport strip E2, there is the opposite transport holder E3*, which is preferably configured identically to the transport holder E3, but is arranged on the opposite side on the central platform holder.

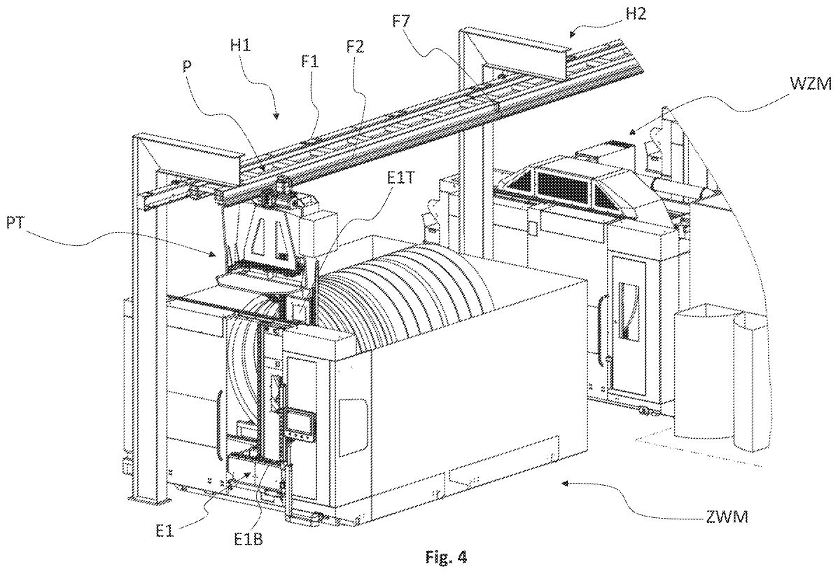

FIG. 4 shows an overview of the central tool magazine ZWM and the transport platform PT placed thereabove. The illustration shows the tool provision strip E1B of the central tool magazine for manual loading, with an additional tool provision strip E1T and a telescopic lift being moved vertically upwards to the transport platform PT for transferring the tools W. Here, the tool lift T of the central tool magazine includes telescopic elements to enable the tool provision strip E1T attached thereto to be extended. The tool provision strip E1B may be loaded with appropriate tools by a manipulator of the central tool magazine in a neutral position, that is, in a position in which the telescopic lift T is retracted. In addition, the manipulator may also appropriately arrange corresponding tools from the tool provision strip E1T and E1B and the wheels of the wheel magazine of the central machine tool.

After equipping the tool provision strip E1T, it can be moved upwards in the vertical direction via the tool lift beyond the top side of the central tool magazine in order to reach an engagement position with the transport platform PT; the tool provision strip E1B and E1T in turn includes tool holders, preferably eight, for example, i.e. corresponding to the number of transport holders E3 of the tool transport strip E2 of the transport platform PT. The tool provision strip E1T is brought into an overlapping position with the transport bracket E3 of the tool transport strip E20, so that the tools can be gripped. By means of a corresponding upward stroke or downward stroke, the tools can be removed or the tools can be inserted into the tool transport strip E2. This vertical stroke is preferably implemented via the tool lift T. After successful transfer, the tool provision strip E1T may be moved from the transfer position back to the neutral position, so that no components protrude from the top side of the central machine tool and a movement of the transport platform PT or the transport module P along the transport path is possible. Alternatively, however, it is also possible for the transport platform PT to carry out a rotational movement, so that the opposite transport holder E3* is now arranged at the front and the tool transport strip E2 of the opposite transport holder E3* is brought into the transfer position, so that, with a corresponding vertical movement of the tool lift T, the tool provision strip can in turn be moved into the transfer position and a transfer of tools of the opposite transport holder E3* can be carried out.

Therefore, the rotational movement of the transport platform PT allows for both tool transport strips to be equipped with tools or tools to be removed. For example, a plurality of new tools may be inserted into the first tool transport strip E2. After rotation of the transport platform PT, tools, for example, can be removed from the second tool transport strip, so that, for example, tools that are no longer required can be inserted back into the central tool magazine. The transport platform PT according to the invention therefore allows tools to be inserted and removed at the same time without having to navigate to another stop.

The supporting guide F, as shown in FIG. 4, includes the first and second rails F1 and F2. The rails each have fastening points F7, at which the rails are extended along the transport path. The first stop H1, shown for example in FIG. 4, is arranged directly above the central tool magazine. The second stop H2 is arranged above a first machine tool WZM. Each stop H preferably has a support arrangement consisting of a vertical support F4 and a horizontal support F3 to stabilize the transport module during the tool transfer process.

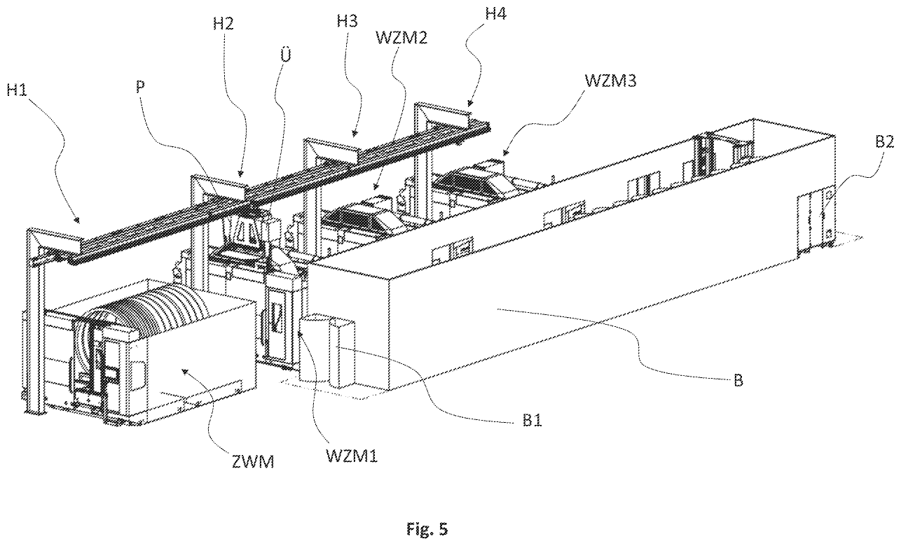

A further diagram of an entire production system is shown in FIG. 5. The central tool magazine ZWM is arranged at an end portion or at the end of the transport path of the supporting guide F. Alternatively, in a particularly advantageous further development, the central tool magazine is arranged in the middle of the transport path, so that the transport module can travel from the central tool magazine to different machine tools on both sides.

In FIG. 5, for example, three machine tools WZM1, WZM2 and WZM3 are shown. These machine tools are arranged sequentially along the supporting guide F. Each of the machine tools has its own stop H2, H3, H4. In FIG. 5, for example, a transfer of tools at the first machine tool WZM1 with the transport platform PT is shown, with a tool provision strip of the machine tool being moved to the transfer position U for this purpose. Parallel to the machine tools WZM1 to WZM3, there is a loading portion B, which has, for example, the first and second door openings B1 and B2. For example, workpieces or blanks may be provided or removed at the machine tools.

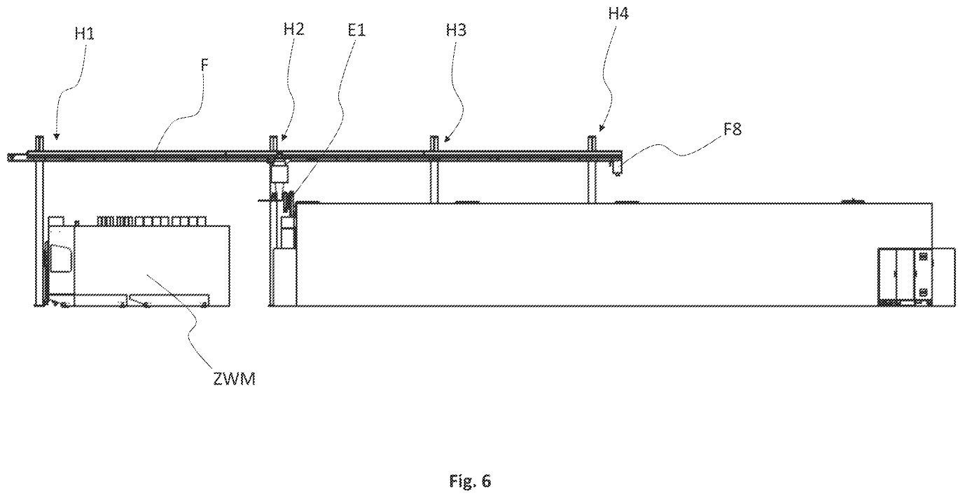

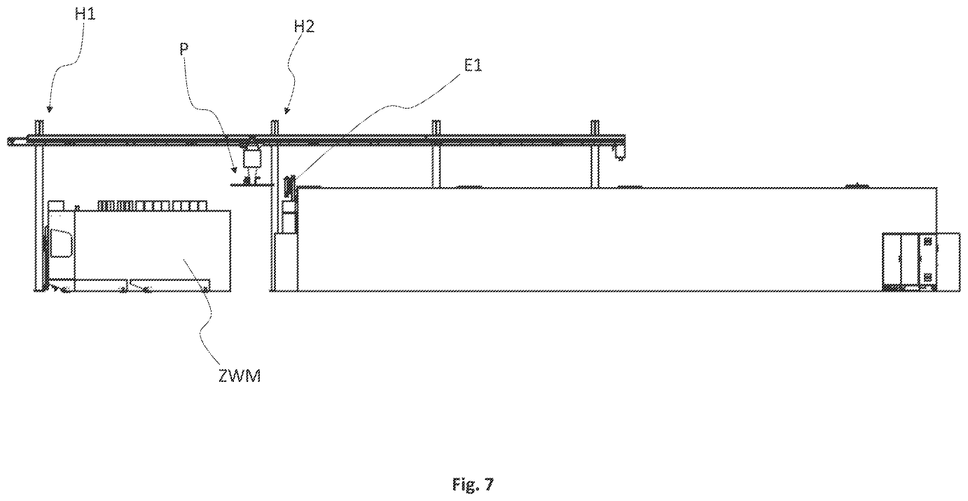

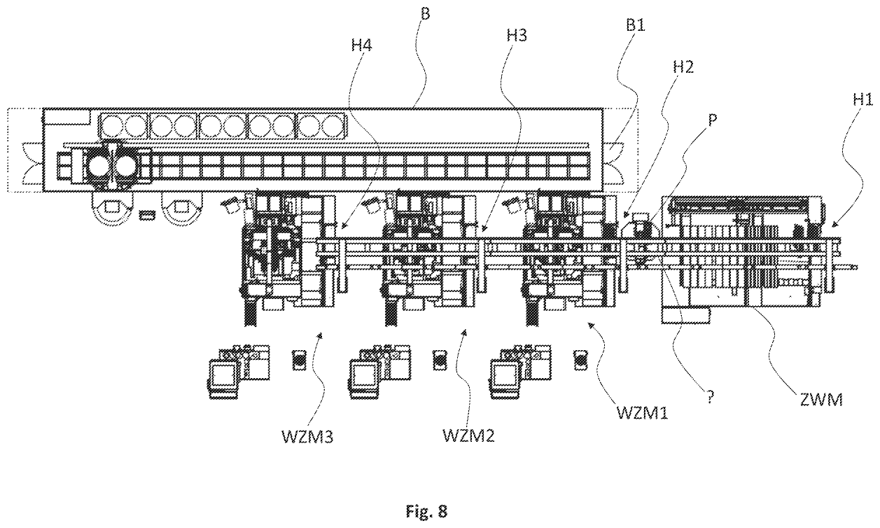

FIG. 6 and FIG. 7 show a further side view of the production system shown in FIG. 5. As is apparent from the figures, the transport module moves along the transport path on the supporting guide F between the individual stops H1 to H4 in order to insert or remove tools. As shown in FIG. 6, the tool lift may be in a vertically extended position, so that a transfer position is reached and the tool provision strip E1 is configured for contact with the tool transport strip E2 of the transport module P. After the transfer process, the transport module may, as shown for example in FIG. 7, move from one stop to the next stop in order to receive or supply tools there. FIG. 8 shows a top view of the production system and the arrangement of the machine tools in parallel to each other along the transport path.

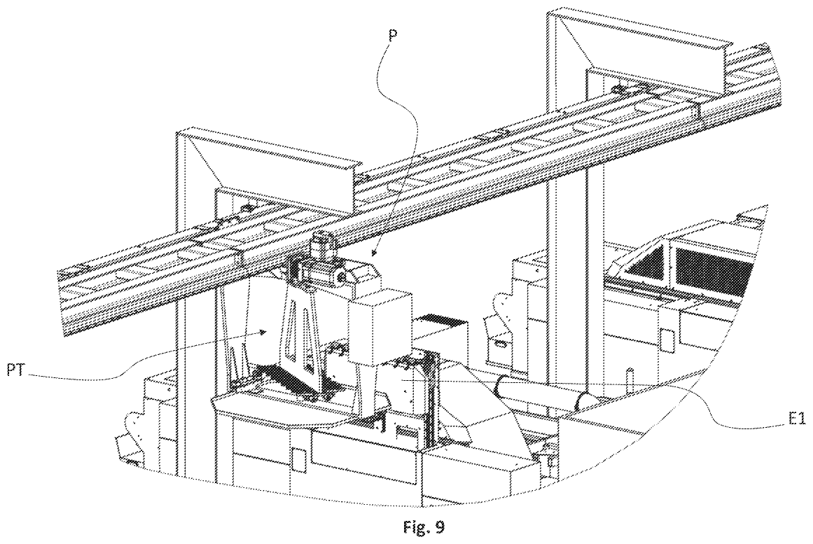

FIG. 9 shows a diagram in which the transport module is shown in the area of a stop, with the transport platform PT being in a rotational movement. For example, a tool changing process may have been carried out with the first tool transport strip E2 and now a further changing process may be carried out with the second tool transport strip. As shown in FIG. 9, the tool lift is in a vertically extended position, so that the tool provision strip is in the transfer position. In order to enable contact between the transport holders of the transport module and the tool provision strip, the collecting trough PR6 may be at least partially retracted or folded.

Above, examples or embodiments of the present invention as well as modifications and advantages thereof have been described in detail with reference to the accompanying figures. However, the following invention is in no way limited or restricted to the exemplary embodiments and features described above, but further modifications of the exemplary embodiments are included, in particular within the scope of the claims.

1. A tool transport system for exchanging tools between a central tool magazine (ZWM) and one or more machine tools (WZM),
wherein said tool transport system comprises:
a guided transport module (P) for shuttling between a central tool magazine (ZWM) and one or more machine tools (WZM) along a transport path;
a supporting guide (F) for receiving said transport module (P) and for determining the transport path of said transport module (P),
wherein said transport module (P) comprises a transport platform (PT) having at least one tool transport strip (E2) for receiving a plurality of tools (W), and wherein said transport platform (PT) is preferably downwardly spaced apart from said transport module (P) in the vertical direction.

2. The tool transport system according to claim 1, wherein said transport platform (PT) is configured to be rotatable about a vertical axis in order to change the spatial orientation of said tool transport strip (E2).

3. The tool transport system according to claim 1, wherein a support frame (PR) for receiving and rotatably mounting said transport platform (PT) is provided and wherein said support frame (PR) preferably completely frames said transport platform (PT) in at least one plane and said support frame (PR) is preferably provided hanging on said transport module (P).

4. The tool transport system according to claim 1, wherein said transport module (P) includes a first drive (A1) for moving along the transport path and a second drive (A2) for rotating said transport platform (PT) about a vertical axis.

5. The tool transport system according to claim 1, wherein said supporting guide (F) is arranged vertically spaced from said central tool magazine (ZWM) and/or said machine tools (WZM) and wherein said supporting guide (F) is preferably arranged at least partially above said central tool magazine (ZWM) and/or said machine tools (WZM).

6. The tool transport system according claim 1, wherein said supporting guide (F) comprises at least one rail (S1, S2), on which guide means (S) of said transport module (P) engage, said transport module (P) being displaceable and preferably being mounted only on said supporting guide (F).

7. The tool transport system according to claim 1, wherein said transport platform includes a first tool transport strip (E2) and a second tool transport strip (E2), preferably arranged opposite one another, and each tool transport strip (E2) comprises a plurality of transport holders (E3) for storing tools (W), wherein a tool change with the first or second tool transport strip (E2) is made possible by rotating said transport platform (PT) about the vertical axis, which is preferably the longitudinal axis of said transport platform (PT).

8. The tool transport system according to claim 1, wherein said transport platform (P) is received on a mounting shaft (PTL) and said mounting shaft (PTL) is mounted on said support frame (PR), wherein said second drive (A2) is connected to the mounting shaft (PTL) by means of engaging means and rotates said mounting shaft (PTL) in order to rotate said transport platform (PT).

9. The tool transport system according to claim 1, wherein said supporting guide (F) has stops (H) along the transport path, which are each assigned to said central tool magazine (ZWM) and the at least one machine tool (WZM) and at which said transport module (P) stops to exchange tools.

10. The tool transport system according to claim 1, wherein said transport module (P) is a shuttle car with rollers which includes a self-drive which drives said transport module (P) along the rails of said supporting guide (F), and wherein the self-drive is in particular said first drive (A1).

11. A production system comprising at least one machine tool (WZM), a central tool magazine (ZWM) for storing tools (W) and a tool transport system according to claim 1,
wherein said central tool magazine (ZWM) and the at least one machine tool (WZM) each include a tool provision strip (E1B) that can be moved into a transfer position for exchanging tools with said tool transport strip (E2) of said transport module (P).

12. The production system according to claim 11, wherein said tool provision strip (E1B) can be moved vertically upwards into the transfer position and back and wherein said tool provision strip (E1B) is configured to carry out an upward lifting movement or a downward lifting movement in order to transfer the tools to said tool transport strip (E2) in the transfer position.

13. The production system according to claim 11, wherein, in order to transfer said tools (W), said tool transport strip (E2) is configured to move into an overlapping position with said tool provision strip (E1B) so that tool grippers of said tool transport strip (E2) and said tool provision strip (E1B) are arranged one above the other.

14. A method for exchanging tools between a central tool magazine (ZWM) and one or more machine tools (WZM) by means of a tool transport system,
wherein said central tool magazine (ZWM) and the at least one machine tool (WZM) each include a tool provision strip (E1B) and said tool transport system comprises: a guided transport module (P) having at least one tool transport strip (E2) and a supporting guide (F) for receiving of said transport module (P) and for determining the transport path of said transport module (P),
wherein said method comprises the steps of:
shuttling said transport module (P) between stops (H) of the transport path at a central tool magazine (ZWM) and one or more machine tools (WZM) along a transport path;
exchanging tools (W) at said stops (H) by means of a lifting movement of said tool provision strip (E1B).

15. The method according to claim 14, comprising the additional steps of:
moving said tool provision strip (E1B) vertically upwards into a transfer position and then preferably moving said tool transport strip (E2) into an overlapping position with said tool provision strip (E1B); and
for transferring the tools (W) to said tool transport strip (E2) in the transfer position, performing an upward lifting movement or a downward lifting movement of said tool provision strip (E1B); and/or
rotating said transport platform (PT) around a vertical axis to change the spatial orientation of said tool transport strip (E2) for exchanging the tools (W).
